(19) United States
(12) Patent Application Publication
(10) Pub. No.: US 2004/0268129 A1
(43) Pub. Date: Dec. 30, 2004

(54) Electronic file certification method and system

(75) Inventor: Dominique Dubuc, Montreal (CA)

Correspondence Address: ROBIC, CENTRE CDP CAPITAL, 8th Floor, 1001 Victoria Square - Bloc E, Montreal, QC, H2Z 2B7, CA

(73) Assignee: ARCHIDATA INC.

(21) Appl. No.: 10/879,050

(22) Filed: Jun. 30, 2004

(30) Foreign Application Priority Data
Jun. 30, 2003 (CA) 2,434,644

(51) Int. Cl. H04L 9/32; G06F 12/14

(52) U.S. Cl. 713/176; 713/193

(57) ABSTRACT

An electronic file certification, validation or comparison method and system. The method includes the steps of: a) receiving a first file at a server from a first user; b) encoding with an electronic tattoo the first file with a first unique serial code to thereby certify the first file; c) encrypting and storing the first file in the server; d) receiving a second file at the server from a second user, the second file having a second unique serial code; and e) comparing the second unique serial code to the first unique serial code. If the serial codes mismatch an e-mail is sent to the second user indicating that the second file is not certified, or else decrypting the first file, and comparing the second file to the decrypted first file. If the files match an e-mail is sent to the second user indicating that the second file is a true copy of the first file, if not it indicates that the second file is not a true copy of the first file.

### FIELD OF THE INVENTION

The present invention relates to an electronic file certification and validation or comparison method and system, and more particularly to plans and specifications certification and validation or comparison method and system for construction professionals and project managers.

### BACKGROUND OF THE INVENTION

Plans and specifications drafted by construction professionals and project managers, such as civil engineers, are paper based and must bear a special seal that serves to identify the professional and certify that he has approved them.

This paper based certification system is the most widely known and used. Yet it is cumbersome, difficult to file and store, and neither very flexible nor adaptable to the needs and realities of today.

In the past, the main problem with issuing electronic drawings has been certifying the plans and specifications or validating the authenticity of the architect's or engineer's seal.

The conventional method requires that construction professionals make copies of the plans, and then stamp a seal on each copy.

Over time, professionals began stamping their seal on the original draft and making copies already bearing the seal. The advent of computers has made it possible for professionals to digitize their seal and paste it directly onto the original file, which can then be duplicated at will. This method makes it impossible to guarantee that the plan has not been tampered with during transmission, despite the presence of the seal.

E-sealing solutions will forever be only as good as the programmers who design them. Despite several attempts in the past, none has yet to gain favor with construction professionals. The products disappeared with each new AutoCAD™ version release, which inevitably required a newer version of the certification program.

### SUMMARY OF THE INVENTION

According to the present invention, there is provided an electronic file certification and validation method, comprising the steps of:

a) receiving a first file at a server from a first user;

b) encoding with an electronic tatoo the first file with a first unique serial code to thereby certify the first file;

c) encrypting and storing the first file in the server;

d) receiving a second file at the server from a second user, the second file having a second unique serial code; and

e) comparing the second unique serial code to the first unique serial code, and if the serial codes mismatch then sending an e-mail to the second user indicating that the second file is not certified, or else decrypting the first file, comparing the second file to the decrypted first file, and if the files match then sending an e-mail to the second user indicating that the second file is a true copy of the first file, or else sending an e-mail to the second user indicating that the second file is not a true copy of the first file.

According to another aspect of the present invention, there is provided an electronic file certification and comparison method, comprising the steps of:

a) receiving a first file at a server from a first user;

b) encoding with an electronic tattoo the first file with a first unique serial code to thereby certify the first file;

c) encrypting and storing the first file in the server;

d) receiving a second file at the server from a second user, the second file having a second unique serial code; and

e) comparing the second unique serial code to the first unique serial code, and if the serial codes match then decrypting the first file, comparing the second file to the first decrypted file, creating a third file containing changes between the second and first file, and sending an e-mail to the second user containing the third file.

According to yet another aspect of the present invention, there is provided an electronic file certification and validation system, comprising:

a server having a first file receiving means for receiving a first file from a first user;

encoding means for encoding with an electronic tattoo the first file with a first unique serial code to thereby certify the first file;

encryption and storage means for encrypting and storing the first file in the server;

second file receiving means for receiving a second file at the server from a second user, the second file having a second unique serial code;

serial code comparing means for comparing the second unique serial code to the first unique serial code;

decryption means for decrypting the first file;

file comparing means for comparing the second file to the first file; and

e-mailing means for sending an e-mail to the second user containing an indication that the second file is not certified if the serial codes mismatch after being compared by the serial code comparing means, or that the second file is a true copy of the first file if the first and second files match after being compared by the file comparing means, or that the second file is not true copy of the first file if the first and second files mismatch after being compared by the file comparing means.

According to yet another aspect of the present invention, there is provided an electronic file certification and comparison system, comprising:

a server having a first file receiving means for receiving a first file from a first user;

encoding means for encoding with an electronic tattoo the first file with a first unique serial code to thereby certify the first file;

encryption and storage means for encrypting and storing the first file in the server;

serial code comparing means for comparing the second unique serial code to the first unique serial code;

decryption means for decrypting the first file;

file comparing means for comparing the second file to the first decrypted file;

third file creation means for creating a third file containing changes between the second and first file; and

e-mailing means for sending an e-mail to the second user containing the third file.

Basically, the system and method according to a preferred aspect of the present invention replaces the paper seal of the architect and engineer. The seal is substituted with an “electronic tattoo” that identifies the copy as matching the original document registered in a secure legal deposit site. Then, each e-sealed copy is distributed online and can be compared to the registered original, should the need arise to determine its compliance or spot any changes.

The system according to a preferred aspect of the present invention is a B2B e-commerce initiative aimed primarily at construction firms, and more particularly, at construction professionals. It preferably consists of an electronic filing and storage site for construction professionals and project managers who wish to register drawings produced during the course of a construction project.

The system according to a preferred aspect of the present invention also aims to fulfill yet another glaring need in the construction sector: automated transmission from certifying and filing designs, to bidding on and managing the construction of new buildings.

The system according a preferred aspect of the present invention allows for plans to be circulated electronically, authenticated and dated for the purpose of tracking any changes or interventions, complete with a list of all parties having had access to them.

The AutoCAD™ program currently occupies 95% of the construction industry software market. Hence, the system according to a preferred aspect of the present invention includes applications based on the AutoCAD™ model, in order to enable users to add value to their digital plans, and thus better manage their AutoCAD™ driven designs.

The system according to a preferred aspect of the present invention intends to help project managers, designers and contractors share validated plans throughout every step of the process, from the invitation to tender to the actual construction.

The system according to a preferred aspect of the present invention provides a solution to the major problems being experienced by the construction industry in relation to the exchange of digital plans.

Indeed, at present, it is difficult, and even impossible in some cases, to share, and above all, interpret electronic plans without a good amount of effort, even if they are developed with the same design software. Also, construction professionals who send electronic plans worry about the originals being falsified and having to defend themselves against lawsuits. And of course, there is the issue of intellectual property, and unauthorized copying of drawings for resale or other purposes. Furthermore, on a secondary level, the absence of document filing standards makes it fundamentally difficult to distinguish between the original and altered versions of a plan. There also exists the possibility of losing or misplacing the originals, the inconveniences of often having to rush to make copies and deliver the documents.

To the Applicant's knowledge, there is no current solution to these problems anywhere in the world. This is hindering the electronic exchange of digital plans, and to a certain extent, it is hampering construction firms' access to the global economy. The system's key to success therefore preferably lies in its ability to resolve these issues faced by construction professionals and project managers by way of a website that provides universal standards for the entire industry.

Hence, the system acts as an online gateway for drawings produced by construction professionals. Whether CAD drawings or scans, the system according to a preferred aspect of the present invention escorts them from the physical to the virtual world.

When the Quebec and North American construction industries need to conduct business electronically, the system according to a preferred aspect of the present invention can certify documents requested by any department or authority required to use plans and specifications. Services include: plan room, estimates, permit requests, bids, building codes compliance, project coordination, etc.

The invention as well as its numerous advantages will be better understood by reading of the following non-restrictive description of preferred embodiments made in reference to the appended drawings.

### BRIEF DESCRIPTION OF THE DRAWINGS

FIGS. 1 to 4 are conceptual diagrams of a CertiPLAN™ system illustrating different embodiments of the system according to a preferred embodiment of the present invention.

FIG. 5 is a general diagram of the design process according to a preferred aspect of the present invention.

FIG. 6 to 12 are conceptual diagrams of the CertiPLAN™ system illustrating advantages corresponding to different preferred embodiments of the present invention.

FIG. 13 is a conceptual diagram of the CertiPLAN™ system's illustrating an extended network according to a preferred embodiment of the present invention.

FIGS. 14 to 17 are diagrams that illustrate the creation of a prototype for electronic sharing purposes and the conceptual data modeling of the drawings module.

### DETAILED DESCRIPTION OF THE INVENTION

According a first aspect of the present invention, there is provided an electronic file certification and validation method, comprising the steps of:

a) receiving a first file at a server from a first user;

b) encoding with an electronic tattoo the first file with a first unique serial code to thereby certify the first file;

c) encrypting and storing the first file in the server;

d) receiving a second file at the server from a second user, the second file having a second unique serial code; and

e) comparing the second unique serial code to the first unique serial code, and if the serial codes mismatch then sending an e-mail to the second user indicating that the second file is not certified, or else decrypting the first file, comparing the second file to the decrypted first file, and if the files match then sending an e-mail to the second user indicating that the second file is a true copy of the first file, or else sending an e-mail to the second user indicating that the second file is not a true copy of the first file.

It should be noted that the above method is applicable to multiple users with multiple files as will be understood by those skilled in the art. Also, although one server has been mentioned for simplicity purposes, it should be understood that several distributed networks servers may be used to achieve the same results.

The above method may be carried out, for example, in order to certify a file, such as a CAD drawing. The first step requires that a construction professional, or first user, send a copy of his drawing along with his contact information to a server. Preferably, there is a form on a website for this purpose. The CAD drawing is then encoded with a unique serial number for the author, the file and version of the file. A copy is encrypted (for security reasons), compressed and stored in the server. The other copy, with the serial number, is emailed back to the author. Preferably, this step is performed by a robot on the web server. The certified copy is referenced to in a database. The copy returned by e-mail to the author is the one he will distribute with the ‘certified’ mention. He is free to make as many copies as desired, as long as they are not altered.

Thereafter, whenever another party (e.g. another construction professional or contractor or second user) receives a certified copy, he can validate its authenticity, preferably free of charge, by attaching it to an email addressed to the server. The certification site automatically validates the certified copy by using the serial number to match it to the server copy. It then decompresses and decrypts it. The site merely needs to perform a binary check of the file to ascertain the validity of the copies (a very simple computer operation). A separate robot is preferably assigned the task of relaying the results back to the sender, at which point, the validating party receives within a very short timeframe, an email confirming one of three possible outcomes: Yes, it is a true copy of the original; No, it is not a true copy of the original; or Possibly, as the copy was unfortunately never certified.

According to another aspect of the present invention, there is provided an electronic file certification and comparison method, comprising the steps of:

a) receiving a first file at a server from a first user;

b) encoding with an electronic tattoo the first file with a first unique serial code to thereby certify the first file;

c) encrypting and storing the first file in the server;

d) receiving a second file at the server from a second user, the second file having a second unique serial code; and

e) comparing the second unique serial code to the first unique serial code, and if the serial codes match then decrypting the first file, comparing the second file to the first decrypted file, creating a third file containing changes between the second and first file, and sending an e-mail to the second user containing the third file.

The above method may be carried out, for example, by a third party, upon request, may to send back (should the copy not be validated, although certified) to the server a drawing limited to only the changes made between the supposedly certified copy and the original. The request is submitted by email by way of a webpage, where the site consists of a third file containing the changes detected between the other two. The changes reported in the third drawing, which is returned to the third party, may be identified as follows: green for additions, red for deletions, and yellow for changes.

Another aspect of the present invention concerns the legal deposit of construction drawings for project managers. For this step, one must put together a network of sites from each Canadian province, and eventually every U.S. state, in order to comply with security, confidentiality and professional responsibility requirements. Each site would be rolled out jointly with the professional and project management orders and associations in each region, in order to garner the cooperation and consent of every region and each target group (architects and engineers).

In Canada, there already exists several networks where public and private invitations to tender are disseminated. As a result, many groups share the information provided by those issuing the offers to bid and then re-distribute it to their members. These include the ACQ (Association des constructeurs du Québec), CCA (Canadian Construction Association), and APCHQ (Association provinciale des constructeurs d'habitations du Quebec).

In a first step, an online graphics server may be provided for receiving tender invitations and to re-release them at will so they may be consulted throughout the affected region. Preferably, an XML based interface is used to transmit transactions to a server that manages the invitations.

Preferably, a user needs to complete a profile on a website prior to requesting an offer to bid. The profile provides the website with a series of information required to identify the requester. A record of every request may be kept on the site. The system is secured against fraud or sabotage. Depending on the certification system that is implemented, one can develop a secure extranet server (internet with password) for the purpose of administering access and consultations.

By focusing strictly on the graphics side of the invitations to tender, one can negotiate agreements with existing tender invitation networks and avoid being perceived as a competitor by these. All transactions between the site and the other sites are stored for future reference.

With tender invitation networks often dedicated to specific regions (e.g. a province, state or country), it is preferable to first recreate a network on a regional scale, and then expand to larger markets to include invitations to tender from all over different regions.

For added security, it is preferable to synchronize the databases from the various sites so they all share the latest and same information. For example, if the Ontario site is down, the user will be redirected to the Quebec site.

Another aspect of the present invention revolves around the registration of construction drawings by project managers. This step requires that one assembles a network of sites from each Canadian province, and eventually every U.S. state, in order to comply with security, confidentiality and professional responsibility requirements. Each site is rolled out jointly with the professional and project management orders and associations in each region, in order to garner the cooperation and consent of every region and each target group (architects and engineers).

A first objective is to secure the legal deposit of drawings for bids on behalf of project managers. This requires meeting the main issuers of tender invitations in the provinces, country, and eventually other countries. This kind of deposit involves a data-warehousing-type database design. It requires large-capacity database technologies like Oracle™ or MS Seul Server 7.0™.

Preferably, the system according to the present invention automatically catalogs drawings by project, phases or lots, by stages (preliminary, pre-project, bids, addenda, etc.), by construction professionals, by project type (building or site) and levels (storey or slab). This system is particularly useful for fast-track or design-build projects with numerous construction lots requiring several separate tender invitations, and consequently, many CAD drawing to manage. Or for long-term projects that require independent follow-ups, given the number of changes requested by the parties involved, including the individuals in charge of the project themselves.

On the system site, project managers can register their drawings and access them whenever they desire, while being assured of their legality and contents in the event of a dispute with their construction professionals or contractors. The site rests on the North American principle and practice of “partnering” when undertaking a construction project. It consists of persuading all the parties involved in a project to forego conflicts and legal recourse by clearly outlining the rules in advance.

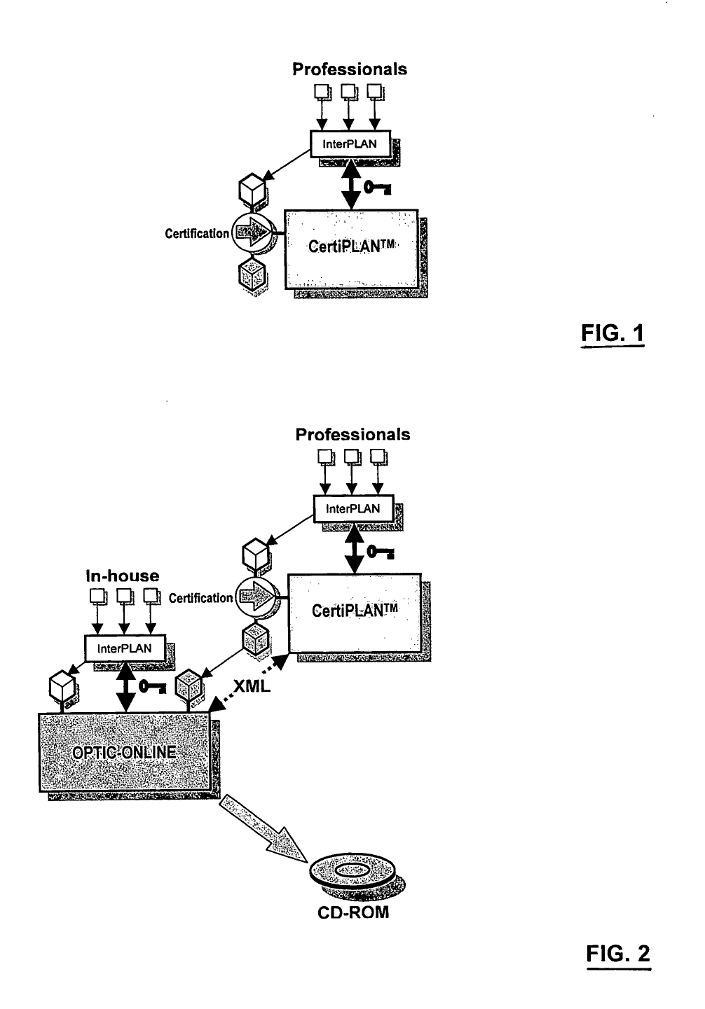

With reference to FIGS. 1 to 4, the diagrams show the flow of information of a plan certification system (CertiPLAN™) according to a preferred embodiment of the present invention. Each of the four diagrams tracks the evolution of the implementation process all the way through to the system's completion.

Referring to FIGS. 1 and 2, Phase 1 of the system preferably consists of the following steps:

1a A construction professional wishing to submit his plans and specifications receives an email from OPTIC-ONLINE asking him to open a CertiPLAN™ account.

1b After activating the project with the contact information from the email, CertiPLAN™ contacts OPTIC-ONLINE by way of an XML transaction.

1c The construction professional downloads a version of the InterPLAN™ module (which is part of the system) and enters his contact information to receive his access key to the project.

1d Drawings and specifications are processed within the lnterPLAN™ module, and an encrypted packet is generated and FTP transferred to the CertiPLAN™ server.

1e The CertiPLAN™ site accepts the transfer and proceeds with the certification and registration of the packet. Each file contained in the packet is e-sealed with a deposit number.

Referring to FIG. 2, Phase 2 of the system preferably consists of the following steps:

2a After an account is opened in OPTIC-ONLINE™, a version of the lnterPLAN™ module is downloaded onto one of the project manager's stations.

2b The data related to the projects and construction professionals are XML transferred to the online system. An access key is generated and transmitted to the InterPLAN™ module.

2c Drawings and specifications are processed within the InterPLAN™ module, and an encrypted packet (password-protected ZIP file) is generated and FTP transferred to the OPTIC-ONLINE™ server.

2d When an invitation to tender is issued, a request is sent to the OPTIC-ONLINE™ server and a CD-ROM is produced.

2e The CD-ROM houses a storage structure for drawings and specifications as well as an HTML site map using WHIP and PDF files for viewing.

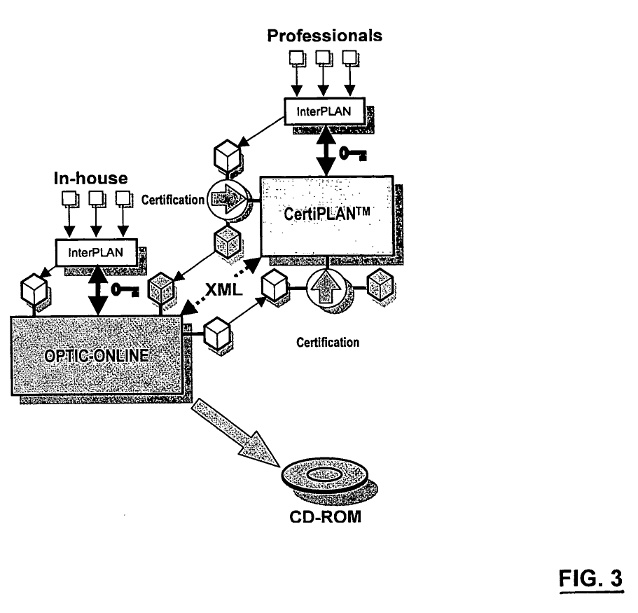

Referring to FIG. 3, Phase 3 of the system preferably consists of the following steps:

3a Once a CertiPLAN™ account is opened, a project is activated by way of a transfer between CertiPLAN™ m and OPTIC-ONLINE™.

3b A packet is selected in OPTIC-ONLINE™. It is then automatically FTP transferred to CertiPLAN™ by way of an encrypted packet (password-protected ZIP file).

3c The CertiPLAN™ site accepts the transfer and proceeds with the registration of the packet. Each file contained in the packet is e-sealed with a deposit number.

3d E-sealed files are deposited in the CertiPLAN™ site for consultation and downloading 24-7 by authorized users.

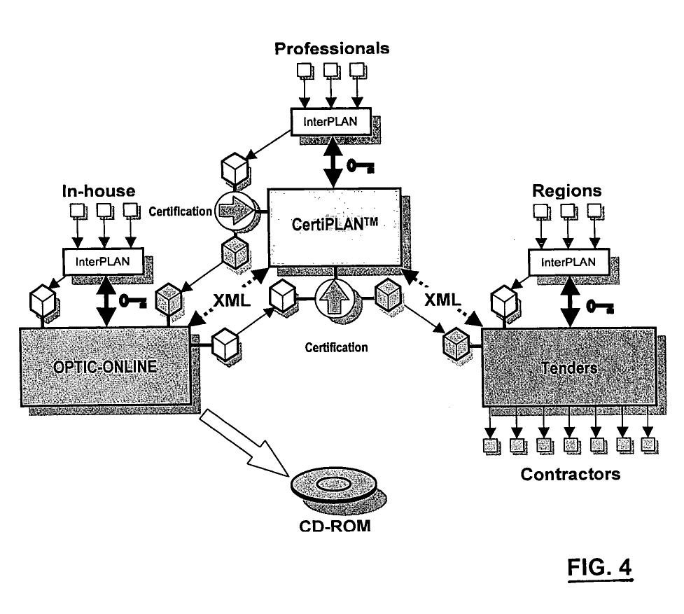

Referring to FIG. 4, Phase 4 of the system preferably consists of the following steps:

4a When CertiPLAN™ activates a project, it is matched by way of an XML transaction to a project in the public bids server.

4b When a packet (encrypted ZIP file) is CertiPLAN™ registered and certified, it is automatically converted to the format of the public bids server.

4c The packet is then transferred to the public bids server and processed as if it had been produced and deposited by one of its regions through the InterPLAN™ module.

4d The transferred packet (encrypted ZIP file) will have been certified, and a copy of the certification is returned to the individual who registered it. The recipient receives a confirmation by email.

4e All the files in the certified packet will have been e-sealed with a deposit number, so that those authorized by the system can track them at all times.

The system according to a preferred aspect of the present invention is simple and user-friendly to construction professionals, and is not affected by changes or upgrades to AutoCAD™, hence, is not destined to become obsolete any time soon. Also, this solution has the advantage of being web based. In essence, it is a website for the certification of drawings intended for construction professionals worldwide. The purpose of the website is to render possible comparisons between a registered original drawing and any other copies issued thereafter.

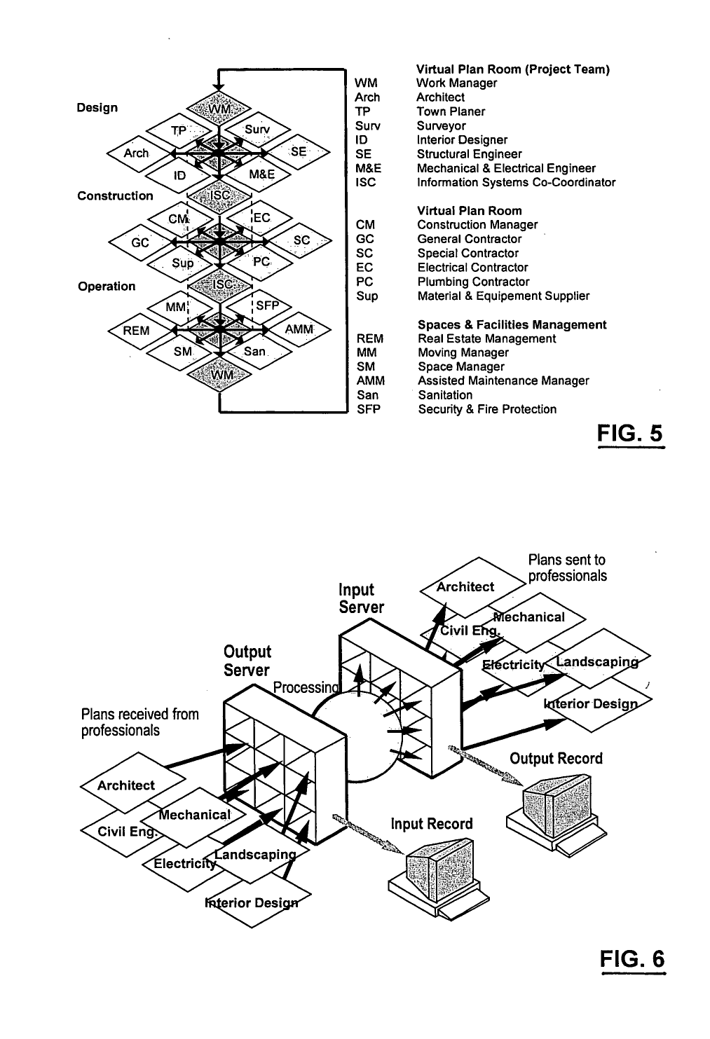

Referring to FIG. 5, there is shown a general diagram of a design process according to a preferred aspect of the present invention.

Referring to FIG. 6, there is shown a diagram of the CertiPLAN™ system, illustrating how it may embody a quality control tool for electronic sharing between all parties involved in a project throughout the design and construction phases.

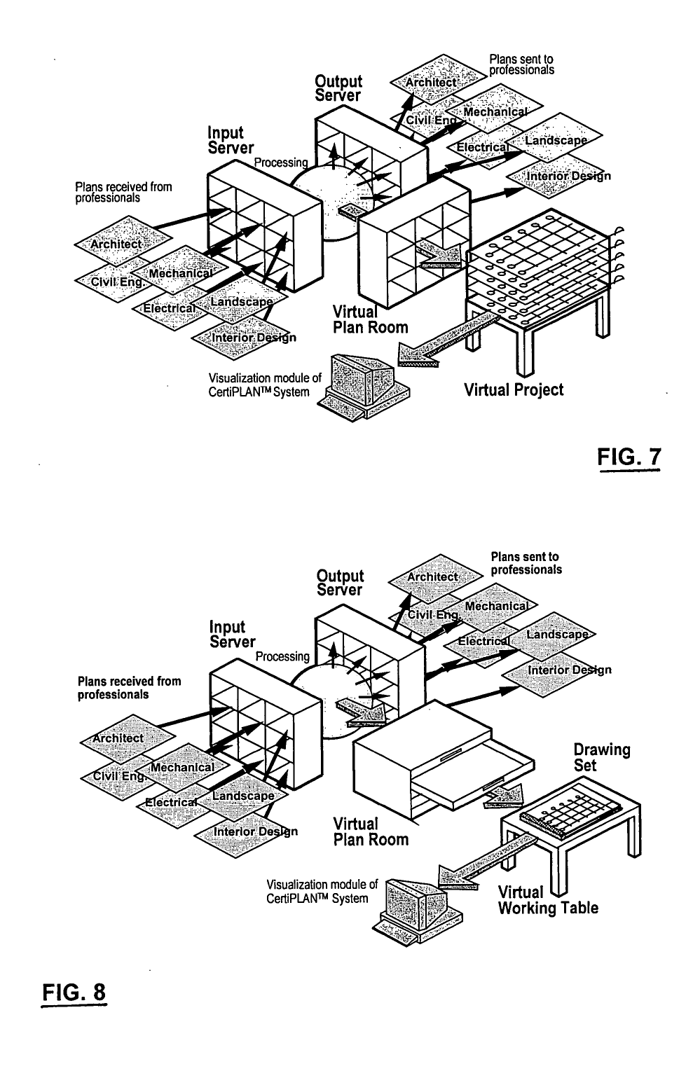

Referring to FIG. 7, there is shown a diagram of the CertiPLAN™ system, illustrating how it may allow for the drawings' contents to be monitored.

Referring to FIG. 8, there is shown a diagram of the CertiPLAN™ system, illustrating how it may allow for traced drawings and the issuance of plans to be monitored.

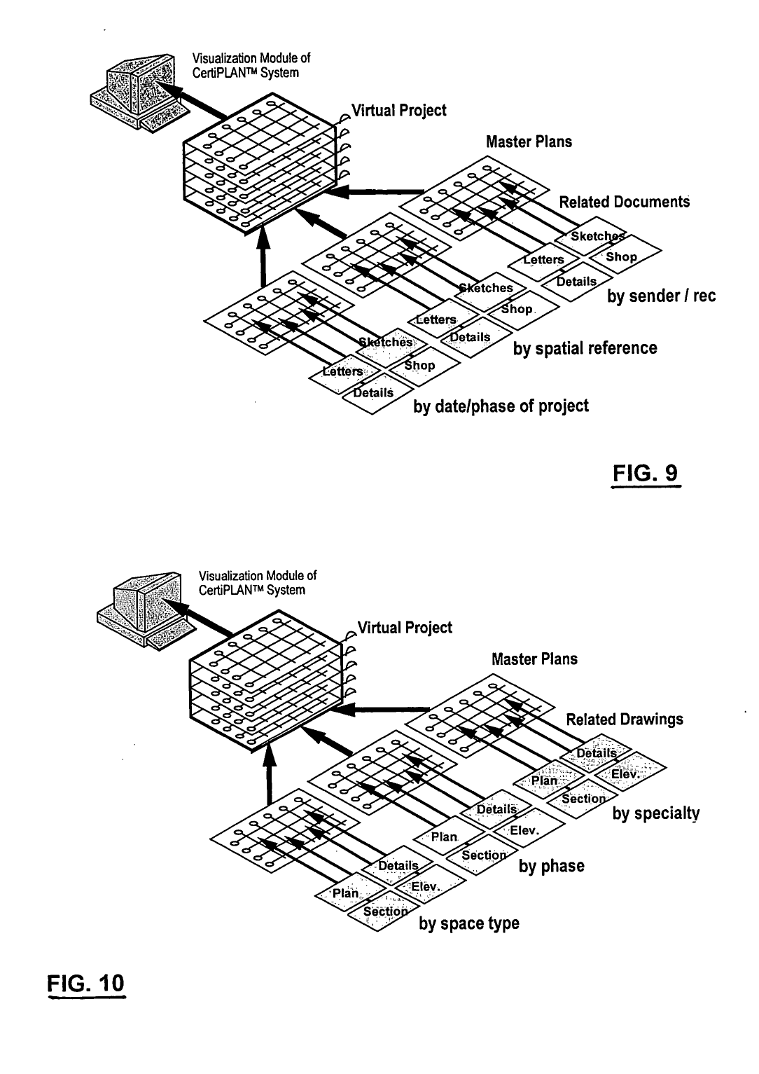

Referring to FIG. 9, there is shown a diagram of the CertiPLAN™ system, illustrating how it may embody a data modeling tool for relational data sourced from graphical and alpha digital documents. The resulting consolidation of technical information helps support the coordinative and contracting components of the project.

Referring to FIG. 10, there is shown a diagram of the CertiPLAN™ system, illustrating how it may allow for the management of a project's drawings and documents.

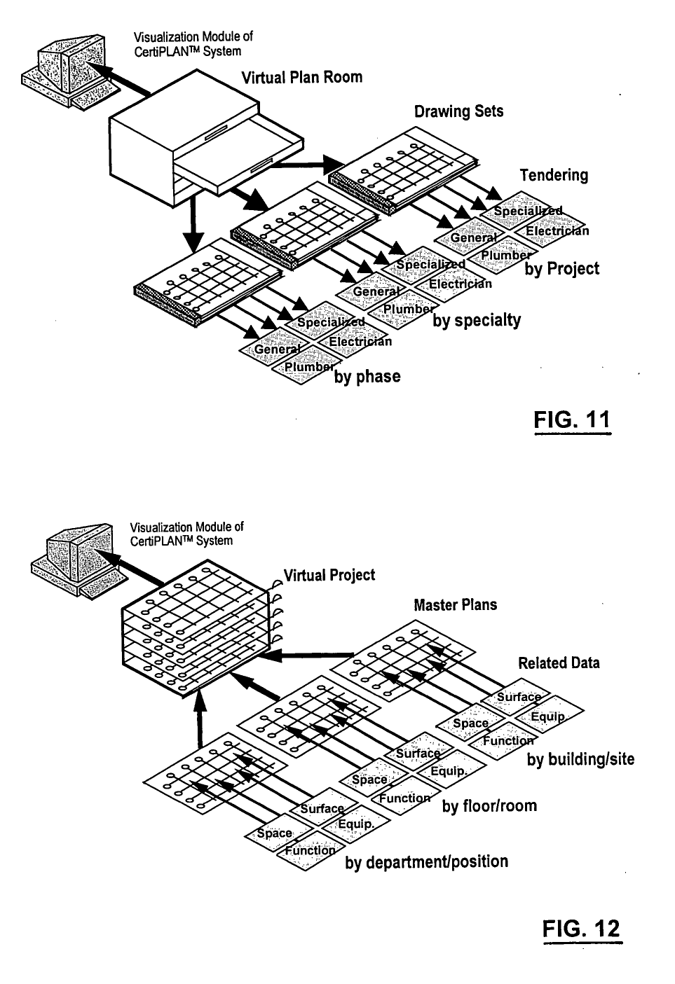

Referring to FIG. 11, there is shown a diagram of the CertiPLAN™ system, illustrating how it may manage and verify the contents of plotted drawings associated with the tendering process.

Referring to FIG. 12, there is shown a diagram of the CertiPLAN™ system, illustrating how it may manage and verify related alphanumeric data.

The CertiPLAN™ System's Extended Network

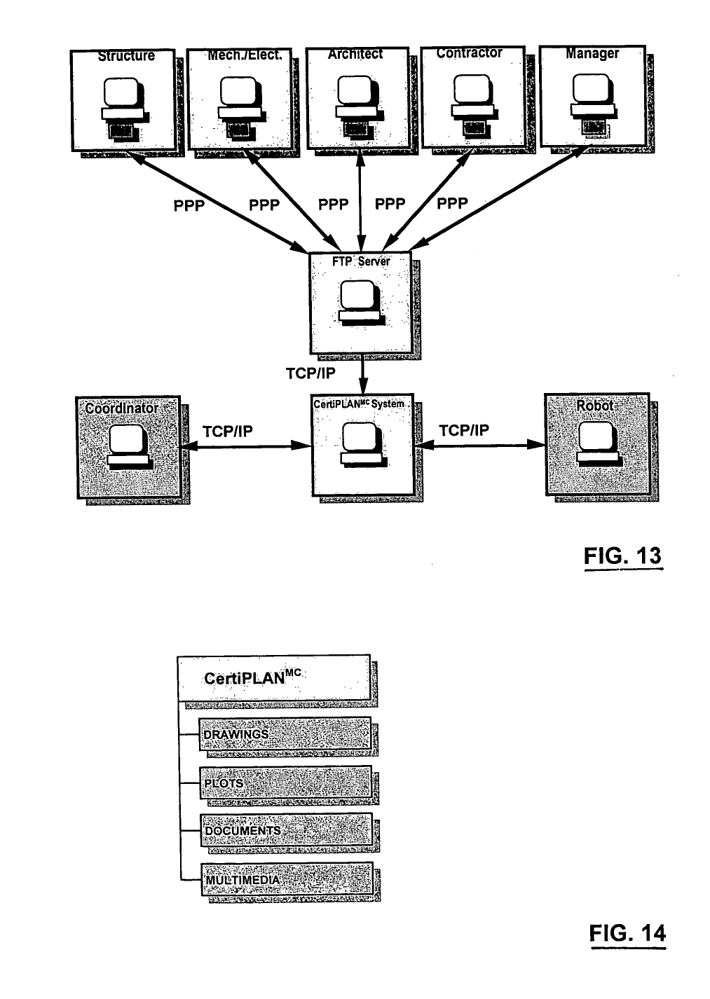

Referring to FIG. 13, there is shown a diagram of the CertiPLAN™ system, illustrating how it may embody a wide area network.

To activate the CertiPLAN™ system, one has to install a network between participating construction professionals. This network is made up of members of the construction team who are linked to an FTP server online through modems with an analog (PPP protocol) or TCP/IP connection.

The FTP (“File Transfer Protocol”) server links the CertiPLAN™ system to the team of construction professionals. The project manager is also connected to the CertiPLAN™ system by way of the TCP/IP network. The FTP server enables the team members to transmit their drawings in DWF (AutoDESK Whip) format.

Other Software Used by CertiPLAN™

The CertiPLAN™ system may require other programs that are important to its operation, These programs are not included in the application:

| | |
|---|---|
| VisualFoxPro7 | Database software (SGBD) from MicroSoft |
| AutoCAD 2002 | CAD software designed by AutoDESK |
| WestWind | Transaction optimization software |
| Web Connect | From WestWind |
| Windows 2000 | Server operating system |
| Server | From MicroSoft with IIS application |

Referring to FIG. 14, there is shown a diagram illustrating the analysis of the file sending and receiving modules.

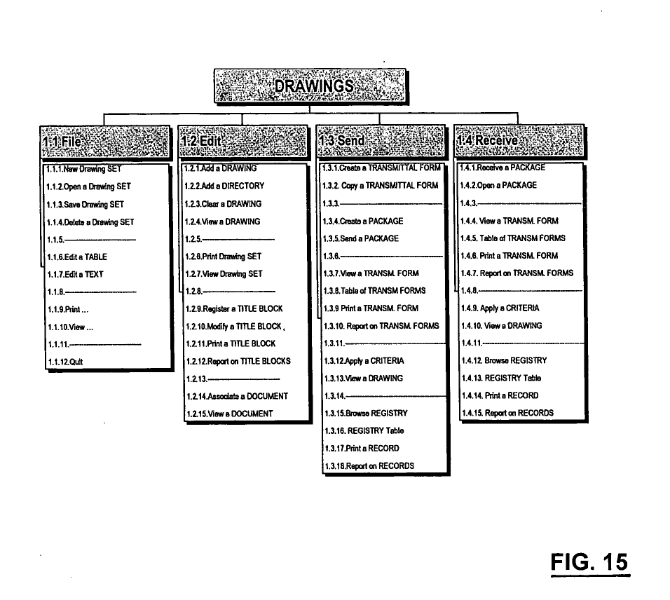

Referring to FIG. 15, there is shown a diagram illustrating a conceptual modelization of data processing for a drawings module.

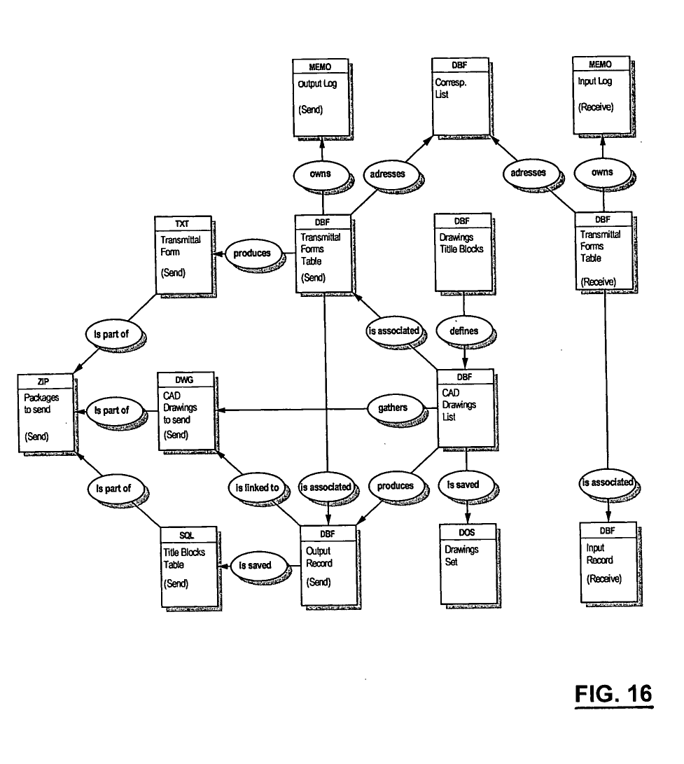

Referring to FIG. 16, there is shown a diagram illustrating a transmission schema for a send module.

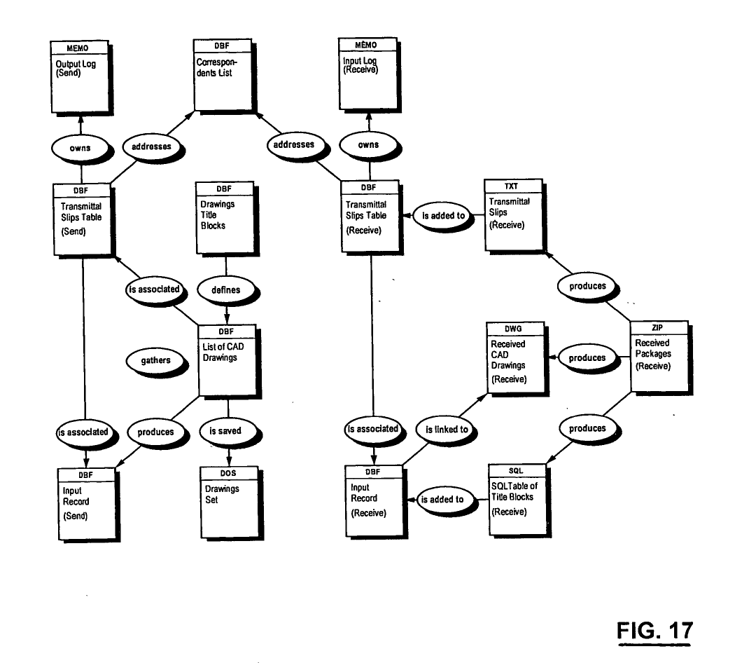

Referring to FIG. 17, there is shown a diagram illustrating a transmission schema for receive module.

This next part deals with some of the conceptual difficulties encountered in the design of the present invention.

Web Transmissions of Vectorial Documents

The extended network is generally made up of several inter-connected servers dispersed across various cities (physical locations).

The transmission of graphical documents over an extended network poses technical problems due to the vast quantity of information that must be transmitted digitally. Graphics files require a lot of memory and are numerous.

One of the difficulties, therefore, resides in the manipulation and transmission of these many heavy files across several sites. These sites can be on separate continents that use different digital transmission protocols, different time zones and numerous carriers of retransmission services.

Synchronizing the Data Over the Network's Various Servers

One of the main problems lies in synchronizing the drawings registry across the complete extended network linking several sites that possess their own registry.

Each site generates drawings, consults drawings from other sites, or combines its drawings with those from other sites. This complicates the monitoring and tracking of updates.

The technical difficulty is in designing a network that synchronizes all transactions (creation, changes, transmission) where they are carried out.

Group Work Over Various CAD Platforms and Operating Systems

Obviously, the situation would be simpler if all parties in the extended network used AutoCAD™. But the reality is that there are always exceptions that render this impossible.

As in the case of software, platforms are not always the same from site to site. Even within the same platform, like PC, there exist fundamental differences between MAC™ and WINDOWS™, for instance.

There will always be new platforms that will join the network. Hence, the difficulty lies in configuring a network that factors in existing and future platforms.

Securing and Protecting Confidential and Essential Data

The extended network interlinks several sites with users having different levels of access that determine their degree of entitlement to the servers' drawings.

Each drawing, as it becomes increasingly conveyed to others, takes on greater importance for the network as a whole. This justifies validating and screening each access to the network through several stages of security.

Providing an extended network to many users dispersed in various locations with assorted ‘clearance’ levels poses network administration problems that have to be factored into the system's design.

Standardizing Graphical Information to Facilitate its Analysis

To communicate among each other on the extended network, parties must be able to share drawings in a universal format. Standardizing the layers' contents is essential to comprehension.

Being able to impose a common standard on all of the construction project teams networkwide would be ideal, but would force each party to increase their non-production costs.

One must, therefore, develop and apply a communication protocol to the extended network that includes a universal standardization system, without compromising the specificity of each site.

Standardizing Electronic Transmissions Between Sites

Controlling network transactions is predicated on creating standardized electronic transmissions between the local and extended networks.

Standardization is governed by an XML protocol in order to guarantee its contractual compliance and validation. Nevertheless, it must take into account the graphical aspect of the transactions.

The difficulty is, therefore, in adapting a system such as XML to a field where the graphical aspect is important, and where the contractual considerations of a transmission are secondary.

Validating the Contents and Professional Responsibility Incurred

The extended network must take into consideration the professional responsibility incurred by each member of the team involved in the construction project.

The drawings' validation system must consider data from various professional sources. Certain drawings are even the result of several disciplines.

The difficulty is in maintaining the legitimacy of the network by preserving the responsibility of each party throughout the various stages of the drawings' handling and transactions.

Sharing the Network's Responsibilities and the System's Reliability

Linking the computer resources of several teams of construction professionals over numerous sites poses problems in terms of co-accountability and reliability.

The network must be able to depend on and contend with the weakest parts of the whole, regardless of the team that houses them.

One of the difficulties is designing a network that adapts to local networks that perform ‘more or less,’ changing at each project on the basis of the new sites joining the community.

Extracting Alpha Digital Data from CAD Plans

Extracting alpha digital data from CAD plans is used from the design phase to the evaluation of maintenance costs or the validation of the architectural programming.

To extract data from CAD drawings, it is important to have consistency in the creation of the drawings and to validate non-graphical content.

The difficulty lies in developing the methodologies for creating, monitoring, recovering and updating the data across the extended network.

Generating Data from a Graphics Structure

Another difficulty triggered by the use of data sourced from a graphical environment is the generation of database queries for assessment purposes.

Alpha digital data from drawings retain a link to the graphical classification on which they are based, even if eventually grouped together in other databases.

It, therefore, becomes imperative to consider a query system that follows graphical reasoning rather than the conventional approach based on conceptual data modeling (CDM).

Viewing Graphical Data and Technical Consolidation of Contents

A technical consolidation of the various disciplines at the design stage is key to achieving construction cost reduction goals.

Technical consolidation refers to the process of validating contents between disciplines to avoid all conflicts and improve the project's coordination.

One of the main difficulties lies in developing a system capable of assembling all the graphical data from a given construction project sector sourced from several servers from various sites.

Storage in the Short/Medium/Long Term and Preservation of Legal Evidence

Each project is broken down into construction phases, which are then divided into lots. Each lot has different stages of progress (preliminary, pre-project, execution, bidding, addenda, etc.).

The system must factor in the progress of each drawing in relation to the overall progress of the actual construction. The drawings must be stored the moment they are replaced by new ones.

The difficulty is in asking the system to track each version of the drawings and to store these in a way that they can be accessed and referred to in future should they need to be consulted or contested.

Temporary Servers Versus Permanent Centers for Storage/Warehousing

The development of the CertiPLAN™ system must take into account that projects are not indefinite, and that the teams behind them are built and disassembled along the way, thus complicating the contiguity of the network.

Relatedly, the members of a team could have their own extended network to handle the many projects they must either carry out or manage on various construction sites.

The system must factor in these elements, and the resulting difficulty is designing a system able to accommodate these two working methods applicable to a same member of the network.

Transmitting Graphical Documents on the Web

At present, the number of web users doubles every nine months. When it will peak is still unknown. And the network as a whole is not yet fully defined.

The consequences of circulating large quantities of graphical files on a network still engaged in defining its objectives and capacity once said network reaches its cruising speed is not yet known.

The difficulty in having the extended network use the web is reconciling the fact that the internet has yet to ‘find itself’ and its reliability at full capacity has yet to be tested.

### Security and Integrity of a Server Linked to a Public Network

The more internet users there are, the more important server security and integrity becomes in terms of ensuring monitored access to and the protection of the drawings being consulted or modified.

Internet users range from recreational browsers merely interested in site hopping to computer professionals that can, whether by accident or willfully, potentially find themselves inside a server from our extended network.

The difficulty here lies in safeguarding the servers from potential intruders, and performing this in a manner that is transparent to regular and legitimate users.

Rapid Evolution of Technologies and Protocols

Finally, the greatest difficulty lies in developing a system that is in lockstep with today's technology, but adaptable to tomorrow's.

Being able to forecast where computer networking technology is heading is a utopian ideal, especially when considering that the internet, unknown by the general population only 10 years ago, is now deemed virtually indispensable.

The system must, therefore, be simple and flexible, able to accommodate new technologies, to avoid creating a system that is already obsolete the minute it is implemented.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. An electronic file certification and validation method, comprising the steps of:
a) receiving a first file at a server from a first user;
b) encoding with an electronic tattoo the first file with a first unique serial code to thereby certify the first file;
c) encrypting and storing the first file in the server;
d) receiving a second file at the server from a second user, the second file having a second unique serial code; and
e) comparing the second unique serial code to the first unique serial code, and if the serial codes mismatch then sending an e-mail to the second user indicating that the second file is not certified, or else decrypting the first file, comparing the second file to the decrypted first file, and if the files match then sending an e-mail to the second user indicating that the second file is a true copy of the first file, or else sending an e-mail to the second user indicating that the second file is not a true copy of the first file.

2. The method according to claim 1, wherein in step a), the server is a web-based distributed network server.

3. The method according to claim 1, wherein step b) comprises the step of e-mailing a copy of the encoded first file to the first user.

4. The method according to claim 1, wherein step b) comprises the step of indexing the first unique serial code in a database and step e) comprises the step of retrieving the first serial code from the database before comparing the first and second serial codes.

5. The method according to claim 1, wherein step c) comprises the step of compressing the first file before storing the first file in the server and step e) comprises the step of decompressing the fist file before decrypting the fist file.

6. The method according to claim 1, wherein the step of comparing the second file to the first file comprises the step of performing a binary check between the second file and the first file.

7. The method according to claim 1, wherein in steps a) and d), the first and second files are CAD drawing files.

8. An electronic file certification and comparison method, comprising the steps of:
a) receiving a first file at a server from a first user;
b) encoding with an electronic tattoo the first file with a first unique serial code to thereby certify the first file;
c) encrypting and storing the first file in the server;
d) receiving a second file at the server from a second user, the second file having a second unique serial code; and
e) comparing the second unique serial code to the first unique serial code, and if the serial codes match then decrypting the first file, comparing the second file to the first decrypted file, creating a third file containing changes between the second and first file, and sending an e-mail to the second user containing the third file.

9. The method according to claim 8, wherein in step a), the server is a web-based distributed network server.

10. The method according to claim 8, wherein step b) comprises the step of e-mailing a copy of the encoded first file to the first user.

11. The method according to claim 8, wherein step b) comprises the step of indexing the first unique serial code in a database and step e) comprises the step of retrieving the first serial code from the database before comparing the first and second serial codes.

12. The method according to claim 1, wherein step c) comprises the step of compressing the first file before storing the first file in the server and step e) comprises the step of decompressing the fist file before decrypting the fist file.

13. The method according to claim 1, wherein in steps a) and d), the first and second files are CAD drawing files.

14. An electronic file certification and validation system, comprising:
a server having a first file receiving means for receiving a first file from a first user;
encoding means for encoding with an electronic tattoo the first file with a first unique serial code to thereby certify the first file;
encryption and storage means for encrypting and storing the first file in the server;
second file receiving means for receiving a second file at the server from a second user, the second file having a second unique serial code;
serial code comparing means for comparing the second unique serial code to the first unique serial code;
decryption means for decrypting the first file;
file comparing means for comparing the second file to the first file; and
e-mailing means for sending an e-mail to the second user containing an indication that the second file is not certified if the serial codes mismatch after being compared by the serial code comparing means, or that the second file is a true copy of the first file if the first and second files match after being compared by the file comparing means, or that the second file is not true copy of the first file if the first and second files mismatch after being compared by the file comparing means.

15. The system according to claim 14, wherein the server is a web-based distributed network server.

16. The system according to claim 14, wherein the e-mailing means include means for sending an e-mail containing a copy of the first encoded file to the first user.

17. The system according to claim 14, wherein the encryption and storage means comprise compression means for compressing the first file and the decryption means comprise decompression means for decompressing the first file.

18. The system according to claim 14, wherein the encryption and storage means comprises indexing means for indexing the first unique serial code in a database and the decryption means comprises retrieving means for retrieving the first unique serial code from the database.

19. An electronic file certification and comparison system, comprising:
a server having a first file receiving means for receiving a first file from a first user;
encoding means for encoding with an electronic tattoo the first file with a first unique serial code to thereby certify the first file;
encryption and storage means for encrypting and storing the first file in the server;
serial code comparing means for comparing the second unique serial code to the first unique serial code;
decryption means for decrypting the first file;
file comparing means for comparing the second file to the first decrypted file;
third file creation means for creating a third file containing changes between the second and first file; and
e-mailing means for sending an e-mail to the second user containing the third file.

20. The system according to claim 19, wherein the first and second files are CAD drawing files.
